(19) United States
(12) Patent Application Publication
(10) Pub. No.: US 2017/0160771 A1
(43) Pub. Date: Jun. 8, 2017

(54) ENHANCED FAN CONTROL IN DATA STORAGE ENCLOSURES

(71) Applicant: HGST Netherlands B.V., Amsterdam, NL (US)

(72) Inventors: Thomas Robert Albrecht, San Jose, CA (US); Darya Amin-Shahidi, San Jose, CA (US)

(21) Appl. No.: 14/957,828

(22) Filed: Dec. 3, 2015

(51) Int. Cl. G06F 1/20; G06F 1/18

(52) U.S. Cl. CPC G06F 1/20; G06F 1/181

(57) ABSTRACT

To provide enhanced operation of data storage devices and systems, various systems, apparatuses, methods, and software are provided herein. In a first example, a data storage system is presented. The data storage system includes data storage devices configured for storage and retrieval of data. The data storage system includes an enclosure that encases and physically supports the plurality of data storage devices, and fan assemblies that provide airflow within the enclosure. The data storage system includes a control processor configured to monitor rotational properties of the fan assemblies and make adjustments to the rotational properties to reduce acoustic disturbances experienced by selected ones of the data storage devices within the enclosure.

### TECHNICAL FIELD

Aspects of the disclosure are related to the field of data storage and control of ventilation fans in data storage enclosures.

### TECHNICAL BACKGROUND

Computer and network systems such as data storage systems, server systems, cloud storage systems, personal computers, and workstations, typically include data storage devices for storing and retrieving data. These data storage devices can include hard disk drives (HDDs), solid state storage drives (SSDs), tape storage devices, optical storage drives, hybrid storage devices that include both rotating and solid state data storage elements, and other mass storage devices.

As computer systems and networks grow in numbers and capability, there is a need for ever increasing storage capacity. Data centers, cloud computing facilities, and other at-scale data processing systems have further increased the need for digital data storage systems capable of transferring and holding immense amounts of data. Data centers can house this large quantity of data storage devices in various rack-mounted and high-density storage configurations.

While densities and workloads for the data storage devices increase, individual data enclosures can experience increased failure rates due to the increased densities and higher operating temperatures. Moreover, tight packing of data storage devices within enclosures, such as within rack-mount modular units, can lead to harsher vibrational environments for data storage devices. These harsh vibrational environments, such as due to fan vibrations or other acoustic disturbances, can affect reliability and readability of data storage devices that incorporate rotating magnetic media.

### Overview

To provide enhanced operation of data storage devices and systems, various systems, apparatuses, methods, and software are provided herein. In a first example, a data storage system is presented. The data storage system includes data storage devices configured for storage and retrieval of data. The data storage system includes an enclosure that encases and physically supports the plurality of data storage devices, and fan assemblies that provide airflow within the enclosure. The data storage system includes a control processor configured to monitor rotational properties of the fan assemblies and make adjustments to the rotational properties to reduce acoustic disturbances experienced by selected ones of the data storage devices within the enclosure.

In another example, a method of operating a data storage system is provided for a data storage system comprising one or more fan assemblies that provide airflow within an enclosure housing a plurality of data storage devices. The method includes, in a control processor, monitoring rotational properties of the one or more fan assemblies, and making adjustments to the rotational properties to reduce acoustic disturbances experienced by selected ones of the plurality of data storage devices within the enclosure.

In another example, a control system is provided for a data storage system that comprises one or more fan assemblies to provide airflow within an enclosure that houses one or more data storage devices. The control system includes a communication interface configured to receive data related to rotational properties of the one or more fan assemblies. The control system includes control circuitry configured to monitor acoustic disturbances within the enclosure, and determine altered rotational properties for the one or more fan assemblies to reduce acoustic disturbances experienced by the one or more data storage devices within the enclosure. The communication interface is configured to transfer control instructions indicating the altered rotational properties for receipt by the one or more fan assemblies.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a data system.

FIG. 2 is a flow diagram illustrating a method of operation of a data storage system.

FIG. 3 is a system diagram illustrating a data system.

FIG. 4 is a flow diagram illustrating a method of operation of a data storage system.

FIG. 5 is a diagram illustrating frequency and phase characteristics.

FIG. 6 is a block diagram illustrating a control system.

### DETAILED DESCRIPTION

Data storage devices, such as hard disk drives (HDDs), solid state drives (SSDs), and hybrid disk drives that have both rotating and solid state storage elements, can be included in various arrayed configurations, such as rack-mounted modular enclosures which house dozens of individual drives. Cooling or ventilation fans can be included with the enclosures to direct airflow over the various drives. Power supply equipment can also be included to provide power to the various storage devices, to convert input power from a utility or building infrastructure to a form usable by the storage devices.

Drives which incorporate rotating media, such as rotating magnetic media of hard disk drives or hybrid disk drives, among others, also include various electromechanical elements to position read/write heads over the spinning media. These electromechanical elements include armatures, motors, actuators, voicecoils, servos, or other elements which can be affected by vibration of the drive elements themselves or by vibrational environment in which the drives are included. This vibrational environment can include vibrations or acoustic disturbances introduced by the ventilation fans, as well as the drives themselves. For example, a drive which performs many random read/write operations can induce more vibration into the surrounding environment of that drive due to rapid movements of the associated electromechanical elements within the drive. Other components within a storage enclosure, such as fans, can also affect the vibration levels within an associated enclosure. The examples herein discuss various systems, software, devices, and methods to alter the vibrational disturbance environment of a storage enclosure. Specifically, speeds and phase relationships among ventilation fans can be altered to reduce acoustic disturbances to the data storage devices in an enclosure.

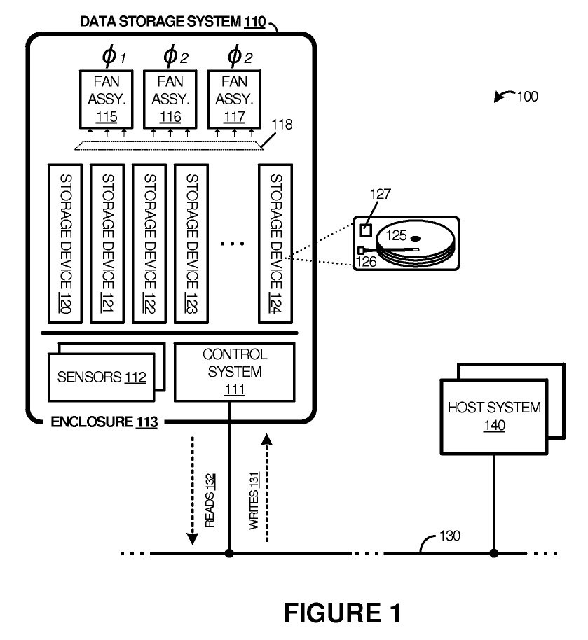

As a first example of a data storage system, FIG. 1 is presented. FIG. 1 is a system diagram illustrating system 100. System 100 includes data storage system 110 and one or more host systems 140. Data storage system 110 and host system 140 communicate over storage link 130. Data storage system 110 can be included in an environment that includes one or more data storage arrays, such as a rackmount computing environment.

In FIG. 1, data storage system 110 comprises an assembly that includes control system 111, sensors 112, enclosure 113, a plurality of fan assemblies 115-117, acoustic attenuator 118, and a plurality of data storage devices 120-124. Each of data storage devices 120-124 can include one or more rotating storage media, such as shown in the detailed view for data storage device 124 as including rotating media 125, read/write heads/armature assembly 126, and vibration sensor 127. In some examples, ones of data storage devices 120-124 include solid state storage media, and may omit rotating media, or can include combinations of rotating and solid state storage media.

Control system 111 is communicatively coupled to data storage devices 120-124 and sensors 112. Although control system 111 is shown as internal to data storage system 110 in this example, it should be understood that in other examples control system 111 can be included in other elements external to data storage system 110. Furthermore, elements of control system 111 can be included in individual ones of data storage devices 120-124.

In operation, data storage system 110 receives read or write transactions over storage link 130 issued by host system 140, such as write operations 131 and read operations 132. Responsive to read operations, individual data storage devices in data storage system 110 can retrieve data stored upon associated storage media for transfer to host system 140. Responsive to write operations, individual data storage devices in data storage system 110 store data on the associated storage media. It should be understood that other components of data storage system 110 and data storage devices 120-124 are omitted for clarity in FIG. 1, such as transaction queues, chassis, interconnect, read/write heads, media, armatures, preamps, transceivers, processors, amplifiers, motors, servos, enclosures, and other electrical and mechanical elements.

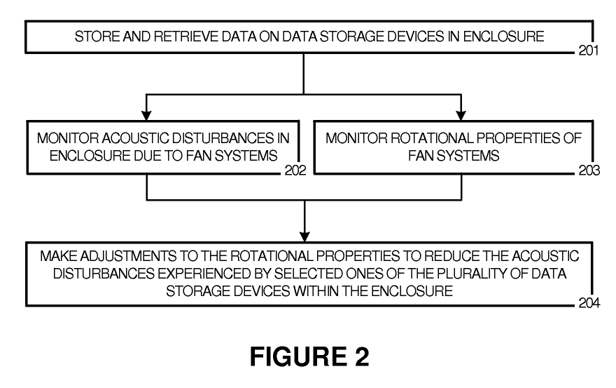

To further illustrate the operation of data system 100, FIG. 2 is provided. FIG. 2 is a flow diagram illustrating a method of operating data storage system 110. The operations of FIG. 2 are referenced below parenthetically. In FIG. 2, data storage system 110 stores and retrieves (201) data in data storage system 110 using data storage devices 120-124 positioned in enclosure 113. Data storage system 110 receives read and write operations over host interface 130 and ones of data storage device 120-124 can handle these operations, such as by storing write data or retrieving read data. Other transactions or operations can be received, such as metadata operations, maintenance operations, or administration operations, among others.

Control system 111 monitors (202) acoustic disturbances in enclosure due to fan systems. In FIG. 1, the fan systems include fan assemblies 115-117, which provide cooling or ventilation to the various components within enclosure 113. Fan assemblies 115-117 include moving elements to force air to flow within enclosure 113. However, movement of elements of fan assemblies 115-117 can introduce acoustic disturbances into enclosure 113, such as vibration, acoustic noise, beat frequency noise, flow-induced disturbances, among other disturbances. For example, when fan assemblies 115-117 include rotating fan elements, phase differences and speed/frequency differences between each of fan assemblies 115-117 can lead to varied acoustic noise within enclosure 113 along with any associated vibrations. These vibrations can be induced into the chassis, structure, or casing of data storage system 110 and be transferred into any of data storage devices 120-124. Acoustic disturbances typically transfers through air within enclosure 113 while disturbances due to fan imbalances mainly transfer through storage system structural elements, such as a chassis elements, drive mounts, or casing portions of enclosure 113. Once introduced into any of data storage devices 120-124, these vibrations can lead to degraded performance due to interaction with electromechanical elements of data storage devices 120-124, such as read/write heads, armatures, servos, voicecoil actuators, or other elements.

The acoustic disturbances can be monitored by control system 111 using various sensors. In some examples, sensors 112 are employed and include acoustic sensing elements, such as accelerometers, microphones, or other acoustic or vibration sensing elements. These sensors can be placed at various locations in enclosure 113 and near each of fan assemblies 115-117 to monitor acoustic disturbances introduced by operation of fan assemblies 115-117. In further examples, ones of storage devices 120-124 can include sensors 127 to sense acoustic disturbances. In yet further examples, data storage devices 120-124 can monitor performance of read/write positioning elements to determine positional error measurements in the operation of the read/write positioning elements which can be correlated to acoustic disturbance for each data storage device. These error measurements can be reported to control system 111 for monitoring of the acoustic disturbances within enclosure 113. A combination of the various monitoring elements can be employed.

Control system 111 monitors (203) rotational properties of fan systems. In addition to monitoring the acoustic disturbance levels within enclosure 113, control system 111 also monitors operation of each of fan assemblies 115-117. In FIG. 1, each of fan assemblies 115-117 includes a rotating fan element which is employed to move air within enclosure 113. These rotating fan elements can include one or more fins that are coupled to a central axis or shaft which rotates responsive to an electric motor or electric drive. Fan assemblies 115-117 can each comprise any fan type, such as axial-flow, centrifugal and cross-flow, or other fan types, including associated ducts, louvers, fins, or other directional elements.

Each of fan assemblies 115-117 can rotate at an associated rotational speed, which can be indicated in revolutions per minute (RPMs), or any angular speed measurement. These associated speeds can be monitored by control system 111. In some examples, control system 111 commands fan assemblies 115-117 to rotate at a selected rotation rate, and thus control system 111 will be aware of the rotational speed of each of fan assemblies 115-117. In other examples, a feedback signal from each of fan assemblies 115-117 can be transferred to control system 111 by an associated fan driver circuit which indicates a monitored speed of each of fan assemblies 115-117. In addition, rotational phases of each of fan assemblies 115-117 can be monitored to identify rotation angles from a reference angle. In FIG. 1, three phases are shown, in an absolute measure based on a reference angle associated with each fan assembly. Phase differences or phase relationships between each fan can also be monitored. For example, when similar or the same model of fans assembly is employed, then each fan can have a rotational phase relationship to each other fan based on a present angle of rotation. A reference angle can also be employed which baselines rotational angles and from which phase differences can also be determined.

Control system 111 makes (204) adjustments to the rotational properties to reduce the acoustic disturbances experienced by selected ones of the plurality of data storage devices within the enclosure. Once various acoustic disturbance levels are monitored and determined for various locations within enclosure 113, then control system 111 can selectively make adjustments to fan assemblies 115-117 to reduce the acoustic disturbance levels for ones of data storage devices 120-124. For example, when one of the data storage devices is experiencing acoustic disturbance levels above a threshold level, which can be for a particular frequency or frequency range, then control system 111 can modify the rotational speeds, relative speeds, phase relationships, or other properties of fan assemblies 115-117, including powering down ones of fan assemblies 115-117 in certain examples.

To make the adjustments to fan assemblies 115-117, control system 111 can command each of fan assemblies 115-117 or associated control/driver circuitry to alter a speed of a fan or phase relationship between fans. Many considerations can be included in the adjustments. In one example, control system 111 identifies ones of data storage devices 120-124 with the highest levels of acoustic disturbances from fan assemblies 115-117 and reduces the acoustic disturbances for those data storage devices by altering rotational properties of fan assemblies 115-117. In another example, control system 111 reduces an average acoustic disturbance level within enclosure 113 by altering rotational properties of fan assemblies 115-117. In yet further examples, a specific data storage device is singled out for acoustic disturbance reduction, such as during vibration-sensitive storage operations, which can include sequential write operations for that data storage device. Control system 111 can determine constructive/destructive interference properties of enclosure 113 when processing information to determine the alterations to the rotational properties of fan assemblies 115-117, such as to reduce constructive interference that is localized to vulnerable data storage devices and locate destructive interference near those data storage devices. Fan phase control of fan assemblies 115-117 allows for adjusting constructive/destructive interference of fan acoustic noise, which provides a way to create and move quiet spots within enclosure 113. Other considerations are possible, such as avoiding resonant acoustic frequencies for the data storage devices when selecting rotation rates or phase relationships.

In FIG. 1, acoustic attenuator 118 can be employed. This attenuator 118 can reduce acoustic disturbances for a particular range of frequencies, such as a silencer for specific frequencies. Control system 111 can select frequencies which lie within the attenuation range of attenuator 118.

In yet further examples, beat frequencies can be considered. Beat frequencies are caused primarily by interference between two acoustic signals of slightly different frequencies, and are experienced as periodic variations in intensity or magnitude with a beat frequency comprising the difference between the two frequencies. Beat frequencies can occur when one or more of fan assemblies 115-117 rotate at the same or similar rotational speed. Differences in speeds or frequencies of fan assemblies 115-117 while rotating at similar speeds can lead to “beating” between fan assemblies 115-117 at frequencies correlated to the frequency differences, and thus acoustic disturbances occur at the beat frequencies. Selected beat frequencies can be desirable or undesirable, and control system 111 can selectively operate fan assemblies 115-117 to introduce or avoid such beat frequencies. Beat frequencies are typically at a frequency equal to the difference of associated fan frequencies. Thus, beat frequency is primarily controlled through controlling relative fan frequencies.

Furthermore, during transitions in speed or phase, control system 111 can consider resonant or undesirable frequencies. When transitioning a fan from a first rotation rate to a second rotation rate, control system 111 can transition the fan quickly through rotation rates correlated to undesirable frequencies and slower through rotation rates correlated to more desirable frequencies to minimize disturbance to data storage devices.

Thus, control system 111 can monitor various operational characteristics of fan assemblies 115-117, such as phase and rotational speed, to enhance operation of data storage devices 120-124. Greater performance for data storage devices 120-124 can be achieved, advantageously leading to more reliable data storage during write operations and less bit errors during read operations, among other enhanced operations, including longer lifetimes and mean time between failures.

Although control system 111 and sensors 112 are discussed above as monitoring vibration characteristics or acoustic disturbances and altering or varying storage densities of data storage devices, it should be understood that these operations can be performed by other elements of data storage system 110. For example, each of data storage devices 120-124 can monitor associated vibration levels or acoustic disturbances, such as by employing vibration sensors 127. Data storage devices 120-124 can report these vibration characteristics to control system 111 and control system 111 can responsively alter operation of fan assemblies 115-117.

Returning to the elements of FIG. 1, data storage system 110 comprises a plurality of data storage devices 120-124. These data storage devices are coupled to control system 111 by one or more storage links, which can comprise a serial ATA interface, Serial Attached Small Computer System (SAS) interface, Integrated Drive Electronics (IDE) interface, Non-Volatile Memory Express (NVMe) interface, ATA interface, Peripheral Component Interconnect Express (PCIe) interface, Universal Serial Bus (USB) interface, wireless interface, Direct Media Interface (DMI), Ethernet interface, networking interface, or other communication and data interface, including combinations, variations, and improvements thereof. Data storage system 110 can also comprise cache systems, chassis, enclosure 113, fan assemblies 115-117, interconnect, cabling, or other circuitry and equipment.

Control system 111 includes processing circuitry, communication interfaces, and one or more non-transitory computer-readable storage devices. The processing circuitry can comprise one or more microprocessors and other circuitry that retrieves and executes firmware from memory for operating as discussed herein. The processing circuitry can be implemented within a single processing device but can also be distributed across multiple processing devices or sub-systems that cooperate in executing program instructions. Examples of the processing circuitry include general purpose central processing units, application specific processors, and logic devices, as well as any other type of processing device, combinations, or variations thereof. The communication interfaces can include one or more storage interfaces for communicating with host systems, networks, and the like. The communication systems can include transceivers, interface circuitry, connectors, buffers, microcontrollers, and other interface equipment.

Sensors 112 can include analog or digital vibration sensors or acoustic disturbance sensors configured to detect vibration or acoustic disturbance in enclosure 113, near any of data storage devices 120-124, or associated with other elements of data storage system 110, such as fan assemblies 115-117. Vibration sensors can include accelerometers, gyroscopic sensors, microphones, acoustic sensors, or other vibration sensors. Sensors 112 can also detect failures of various components of data storage system 110, such as failure of power supplies, fans, data storage devices, and the like, which can affect the vibrational environment of data storage system 110. Sensors 112 can also include various interfaces for communicating measured information, such as to control system 111. These interfaces can include transceivers, analog-to-digital conversion elements, amplifiers, filters, signal processors, among other elements. In some examples, sensors 112 can each include microcontroller elements, programmable logic, or discrete logic to control the operations of sensors 112. In some examples, data storage devices 120-124 each can include ones of sensors 112, and data storage devices 120-124 can include equipment and circuitry to transfer sensor information over an associated storage or host interface to control system 111.

Enclosure 113 comprises structural elements to house and structurally support the elements of data storage system 110. Enclosure 113 can include chassis elements, frames, fastening elements, rackmount features, ventilation features, among other elements. In many examples, enclosure 113 also includes fans 1115-117 or other cooling and ventilation elements for providing airflow to the elements of data storage system 110.

Fan assemblies 115-117 provide airflow to elements within enclosure 113, such as the elements of data storage system 110. Fan assemblies 115-117 can comprise any fan type, such as axial-flow, centrifugal and cross-flow, or other fan types, including associated ducts, louvers, fins, or other directional elements, including combinations and variations thereof.

Acoustic attenuator 118 comprises one or more acoustically active materials which can dampen, absorb, reflect, or otherwise alter acoustic properties associated with fan assemblies 115-117. Acoustic attenuator 118 can comprise foams, polymers, metal foams, glass fibers, cellulose, baffles, resonant chambers, or other materials and elements. Acoustic attenuator 118 can include associated casing, structure, attachment points and other elements. In some examples, more than one acoustic attenuator 118 is employed, such as one for each of fan assemblies 115-117. Acoustic attenuator 118 typically has one or more attenuation frequencies or frequency ranges over which acoustic disturbances are attenuated or reduced. This reduction can be due to absorbance properties of the materials employed for acoustic attenuator 118. This reduction can be due to selected physical structures, such as fins, baffles, resonant chambers, or other structures. In further examples, acoustic attenuator 118 include metamaterials which can be selectively tuned though microstructures to dampen certain selected acoustic frequencies.

Data storage system 110 also includes one or more power supplies to convert external input power sources or provide various forms of electrical energy to the elements of data storage system 110. Power supplies can each comprise power conversion elements, power electronics, transformers, voltage conversion circuitry, among other elements. Power supplies can also be included in an assembly with one or more ventilation fans, such as fan assemblies 115-117, to provide cooling and ventilation to the power supplies and to other components in enclosure 113.

Each of data storage devices 120-124 includes one or more computer readable storage media accessible via one or more read/write heads and associated electromechanical elements. In FIG. 1, an example detailed view of data storage device 124 is shown to highlight rotating media 125 and read/write heads and armature assembly 126, and these elements can be included in each of data storage devices 120-124, although variations are possible among the data storage devices, such as when solid state media are employed. Data storage devices 120-124 can also each include processing circuitry, communication interfaces, armatures, preamps, transceivers, processors, amplifiers, motors, servos, enclosures, and other electrical and mechanical elements. Data storage devices 120-124 can each comprise a hard disk drive, hybrid disk drive, solid state drive, or other computer readable storage device, including combinations thereof. Data storage devices 120-124 can each include further elements, such as vibration sensors 127, which can comprise similar elements as sensors 112. The computer readable storage media of data storage devices 120-124 can each include rotating magnetic storage media, but can additionally include other media, such as solid state drive elements, caches, or cache systems. These other media can include solid state storage media, optical storage media, non-rotating magnetic media, phase change magnetic media, spin-based storage media, or other storage media, including combinations, variations, and improvements thereof. In some examples, data storage devices 120-124 each comprise a hybrid hard drive employing solid state storage elements in addition to rotating magnetic storage media. Associated storage media can employ various magnetic storage schemes, such as random write techniques, shingled magnetic recording (SMR), perpendicular magnetic recording (PMR), or heat-assisted magnetic recording (HAMR), including combinations, variations, and improvements thereof.

Host system 140 can include processing elements, data transfer elements, and user interface elements. In some examples host system 140 is a central processing unit of a computing device or computing system. In other examples, host system 140 also includes memory elements, data storage and transfer elements, controller elements, logic elements, firmware, execution elements, and other processing system components. In yet other examples, host system 140 comprises a RAID controller processor or storage system central processor, such as a microprocessor, microcontroller, Field Programmable Gate Array (FPGA), or other processing and logic device, including combinations thereof. Host system 140 can include, or interface with, user interface elements which can allow a user of data system 100 to control the operations of data system 100 or to monitor the status or operations of data system 100. These user interface elements can include graphical or text displays, indicator lights, network interfaces, web interfaces, software interfaces, user input devices, or other user interface elements. Host system 140 can also include interface circuitry and elements for handling communications over bus 130, such as logic, processing portions, buffers, transceivers, and the like.

Bus 130 can include one or more serial or parallel data links, such as a Peripheral Component Interconnect Express (PCIe) interface, serial ATA interface, Serial Attached Small Computer System (SAS) interface, Integrated Drive Electronics (IDE) interface, ATA interface, Universal Serial Bus (USB) interface, wireless interface, Direct Media Interface (DMI), Ethernet interface, networking interface, or other communication and data interface, including combinations, variations, and improvements thereof. Although one bus 130 is shown in FIG. 1, it should be understood that one or more discrete links can be employed between the elements of data system 100.

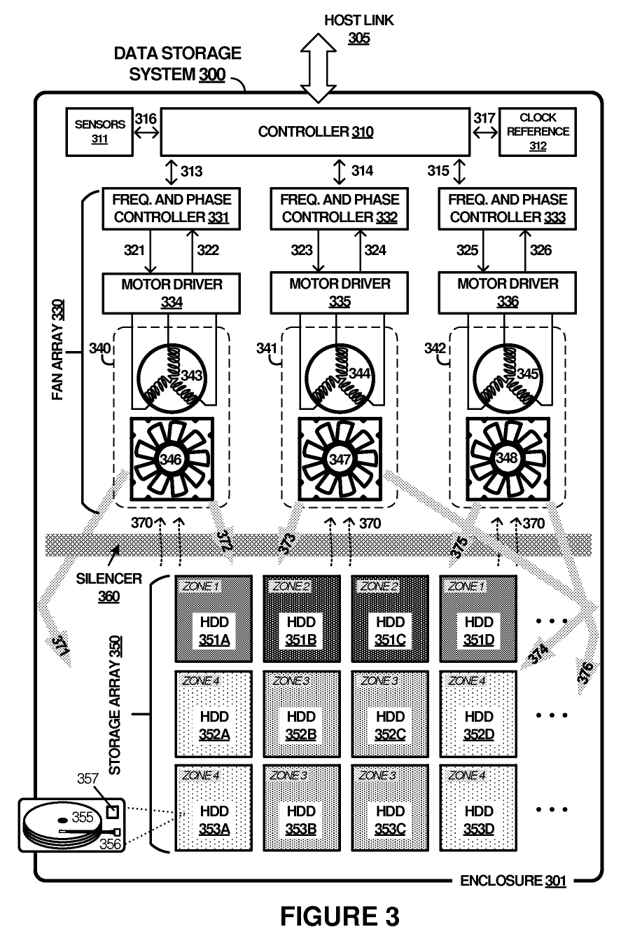

As a further example data storage system employing a data storage array, FIG. 3 is presented. FIG. 3 is a system diagram illustrating a detailed top view of data storage system 300. Data storage system 300 includes enclosure 301 which houses, encases, and structurally supports the elements shown in FIG. 3. Specifically, data storage system 300 includes controller 310, sensors 311, clock reference 312, frequency and phase controllers 331-333, motor drivers 334-336, fan assemblies 340-342, acoustic silencer 360, and a plurality of hard disk drives (HDDs), namely HDDs 351A-351D, 352A-352D, and 353A-353D. Various elements of data storage system 300 can be included in data storage system 110 of FIG. 1, although variations are possible. Although one data storage system 300 is shown in FIG. 3, it should be understood that more than one storage system could be included and linked to a host system, such as in a data storage environment employing many data storage arrays.

Data storage system 300 can comprise a storage assembly with associated enclosure 301 and structural elements which is insertable into a rack that can hold other storage assemblies, such a rackmount server environment. The enclosure can include structural elements, such as a chassis and trays, to mount the plurality of storage drives and can also include at least one external connector for communicatively coupling storage devices to host link 305. In addition to the elements shown in FIG. 3, power supply elements are also included to convert external power sources or provide various forms of electrical power to the elements of data storage system 300.

Data storage system 300 can comprise a redundant array of independent disks (RAID) array, or a JBOD device (“Just a Bunch Of Disks”) device which include a plurality of independent disks which can be spanned and presented as one or more logical drives to a host system. In some examples, data storage system 300 comprises a VBOD (“Virtual Bunch of Disks”) which adds one or more layers of abstraction between physical storage drives and external interfaces. A VBOD can employ various types of magnetic recording technologies and abstract front-end interactions from the particular recording technology. For example, shingled magnetic recording (SMR) hard disk drives typically have inefficiencies for random writes due to the shingled nature of adjacent tracks for data. In SMR examples, the VBOD abstracts the SMR drives and allows random writes and random reads while still having underlying SMR media which ultimately hold the associated data. Other recording techniques can be employed, such perpendicular magnetic recording (PMR), or heat-assisted magnetic recording (HAMR), including variations, improvements, and combinations thereof.

Host link 305 can include one or more links, although a single link is shown in FIG. 3. Host link 305 can comprise a storage or disk interface, such as Serial Attached ATA (SATA), Serial Attached SCSI (SAS), FibreChannel, Universal Serial Bus (USB), SCSI, InfiniBand, NVMe, Peripheral Component Interconnect Express (PCIe), Ethernet, Internet Protocol (IP), or other parallel or serial storage or peripheral interfaces, including variations and combinations thereof.

Data storage system 300 includes a plurality of hard disk drives (HDDs) 351A-351D, 352A-352D, and 353A-353D. Each HDD can be mounted in an associated carrier tray which is further encased in an enclosure to form a storage carrier, although independent mounting can be employed. Each HDD can be inserted and removed into data storage system 300. Each HDD couples to a mating connector and can be communicatively coupled to controller 310. In other examples, each connector is individually coupled over host link 305 to a host system.

An exemplary detailed view of HDD 353A is shown in FIG. 3 to emphasize the rotating storage media 355, read/write head assembly 356, and vibration sensor 357. Each HDD can comprise similar elements, such as rotating storage media, read/write heads, armatures, and optionally vibration sensors, although variations are possible among HDDs. HDDs can include further elements, such as preamps, transceivers, processors, amplifiers, motors, voicecoil actuators, servos, cases, seals, enclosures, and other electrical and mechanical elements. It should be understood that variations are possible for HDD 353A or other HDDs. Each HDD can instead comprise hybrid disk drives which include rotating media and solid state storage components which work in tandem. In further examples, solid state drives (SSDs), optical storage drives, or other non-transitory computer-readable storage devices are employed.

In FIG. 3, each HDD also optionally includes an associated vibration sensor 357, which can comprise an accelerometer, such as a solid-state multi-axis accelerometer or other vibration sensing elements, including associated interface circuitry. These vibration sensors can be included among the electronic or mechanical elements of each HDD, and can measure vibration characteristics associated with the HDD. Alternatively, each HDD can monitor positioning performance for associated read/write heads or read/write head assemblies (which can include armatures and voicecoil actuators or servos). Actual positioning performance for read and write operations can be compared to target positioning for the read/write head assemblies, and deviations or deltas can be identified. Each HDD can also include equipment and circuitry to transfer positioning performance, vibration characteristics, or other vibration information determined by the associated vibration sensors over an associated storage interface to the control system.

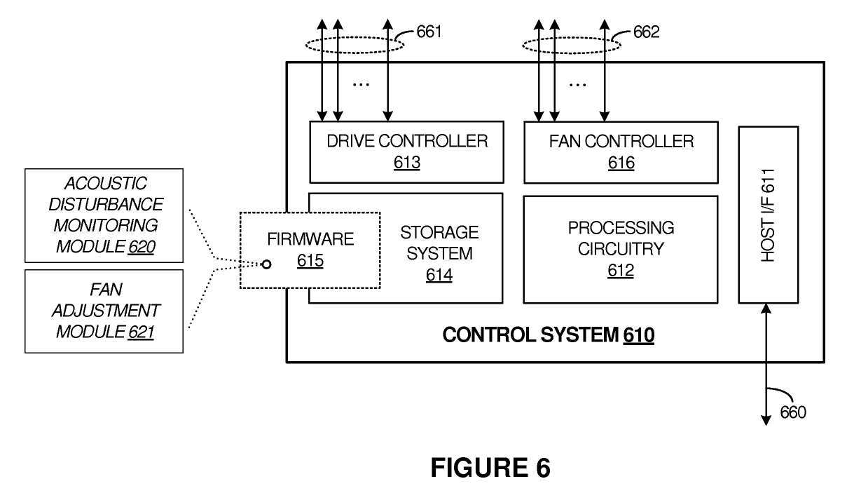

In many examples, controller 310 is communicatively couples to each HDD and presents a unified host link 305 to a host system. Each HDD can be coupled to controller 310 by one or more storage links, such as Serial Attached SCSI (SAS) links, although other link types can be employed. FIG. 6 illustrates control system 610 which can be one example of controller 310 employed in data storage system 300.

Sensors 311 are employed to measure or monitor acoustic disturbances or vibrations within enclosure 301 and comprise acoustic sensing elements, such as accelerometers, microphones, or other acoustic or vibration sensing elements. These sensors can be placed at various locations in enclosure 301 and near each of fan assemblies 340-342 and selected ones of the HDDs to monitor acoustic disturbances introduced by operation of fan assemblies 340-342. Sensors 311 can include similar elements discussed above for sensors 112, such as transceivers, analog-to-digital conversion elements, amplifiers, filters, signal processors, among other elements. Sensors 311 each include equipment and circuitry to transfer sensor information over an associated link 316 to controller 310.

Clock reference 312 comprises circuitry to generate a clock or timing signal which can be employed as a reference for phase measurements associated with fan assemblies 340-342. In some examples, clock reference 312 comprises a crystal oscillator or resonant circuit that generates a periodic signal which can be employed as a stable clock signal 317 for controller 310.

Frequency and phase controllers 331-333 comprise circuitry that receive fan operation instructions from controller 310 over associated link 313-315 and generate control signals for motor drivers 334-336 over links 321, 323, and 325. In some examples, links 313-315 comprise digital links that carry digital instructions from controller 310, and frequency and phase controllers 331-333 convert these digital instructions into analog signaling for delivery to motor driver 334. In some examples, frequency and phase controllers 331-333 receive commands over links 313-315 to alter frequency or phase operations of fan assemblies 340-342 and frequency and phase controllers 331-333 responsively generate signaling to enact the commands. In some examples, frequency and phase controllers 331-333 comprise pulse-width modulation circuitry to control power electronics transistors of motor drivers 334-336. Frequency and phase controllers 331-333 can also comprise phase-locked loop circuitry for maintaining a consistent frequency and phase of operation for motor drivers 334-336 and likewise fan assemblies 340-342.

Motor drivers 334-336 comprise one or more power electronics circuits which provide power and control features to an associated fan assembly 340-342 over motor drive links. Specifically, motor drivers 334-336 can comprise various power control circuitry, such as microcontrollers, power conversion circuitry, transistors, field-effect transistors, power metal-oxide-semiconductor field-effect transistor (MOSFET), insulated-gate bipolar transistors (IGBT), along with associated passive electronic components that drive power to fan motor elements 343-345 of associated fan assemblies 340-342. Motor drivers 334-336 can apply power to fan motor elements 343-345 in accordance with control signaling received over links 321, 323, and 325 to operate fan motor elements 343-345 according to frequency, speed, phase, or other instructions determined by controller 310.

One or more ventilation fans assemblies 340-342 are included to provide airflow to data storage system 300. Fans assemblies 340-342 can comprise any fan type, such as axial-flow, centrifugal and cross-flow, or other fan types, including associated louvers, fins, or other directional elements, including combinations and variations thereof.

In FIG. 3, fans assemblies 340-342 include associated fan motor elements 343-345 and fan blades 346-348. Fan motor elements 343-345 comprise motor coils, such as stator or rotor elements, brush elements, or other motor electrical components. Although three coils per motor are shown in FIG. 3, it should be understood that a different number could be employed. Fan blades 346-348 are coupled to a rotating element of an associated fans assembly 340-342 which are driven by associated fan motor elements 343-345 in accordance with the control imparted by controller 310, frequency and phase controllers 331-333, and motor drivers 334-336. Although a nine-bladed fans are shown in FIG. 3, a different number of fan blades can be included instead.

Acoustic silencer 360 comprises one or more acoustically attenuating materials which can dampen, absorb, reflect, or otherwise alter acoustic properties associated with fan assemblies 340-342. Acoustic silencer 360 can comprise foams, polymers, metal foams, glass fibers, cellulose, baffles, resonant chambers, or other materials and elements. Acoustic silencer 360 can include associated casing, structure, attachment points and other elements. In some examples, more than one acoustic silencer 360 is employed, such as one for each of fan assemblies 340-342. Acoustic silencer 360 typically has one or more attenuation frequencies or frequency ranges over which acoustic disturbances are attenuated or reduced. This reduction can be due to absorbance properties of the materials employed for acoustic silencer 360. This reduction can be due to selected physical structures, such as fins, baffles, resonant chambers, or other structures.

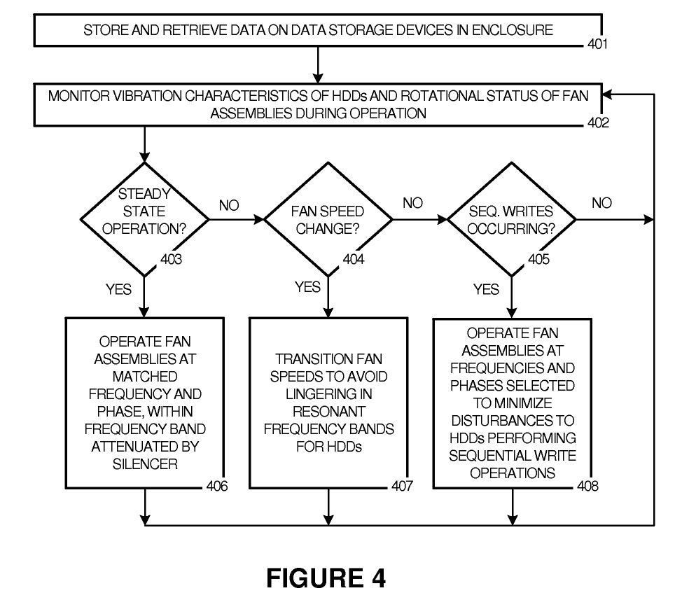

To further illustrate the operation of data storage system 300, FIG. 4 is presented. FIG. 4 is a flow diagram illustrating a method of operation of data storage system 300. The operations of FIG. 4 are referenced below parenthetically. The various operations described herein for FIG. 4 can be performed by any combination of elements in data storage system 300, such as controller 310, frequency and phase controllers 331-333, motor driver 334-336, and HDDs 351A-351D, 352A-352D, 353A-353D, or instead by a host system over host link 305.

In FIG. 4, data storage system 300 stores and retrieves data on data storage devices in enclosure (401), namely using HDDs 351A-351D, 352A-352D, and 353A-353D. Data storage system 300 receives read and write operations over host link 305 and ones of HDDs 351A-351D, 352A-352D, and 353A-353D can handle these operations, such as by storing write data or retrieving read data. Other transactions or operations can be received, such as metadata operations, maintenance operations, or administration operations, among others. In some examples, ones of HDDs 351A-351D, 352A-352D, and 353A-353D can be configured into sequential write modes. The sequential write modes can include bursts of write operations and associated write data which are written in high-density configurations onto storage media of associated HDDs 351A-351D, 352A-352D, and 353A-353D. For example, when ones of HDDs 351A-351D, 352A-352D, and 353A-353D employ shingled magnetic recording (SMR) techniques, then burst sequential writes are typically performed to ensure high density storage on overlapping adjacent tracks of data. However, sequential write operations can be more sensitive to acoustic disturbances and vibrations

Data storage system 300 monitors (402) vibration characteristics of the HDDs and rotational status of fan assemblies 340-342 during operation of data storage system 300. For example, during read and write operations handled by HDDs 351A-351D, 352A-352D, and 353A-353D as well as during idle periods, controller 310 can monitor acoustic disturbances within enclosure 301 as well as vibrational disturbances experienced by each of the HDDs. The vibration levels can be monitored by controller 310 in terms of various metrics, values, or units. For example, an average acoustic energy or vibration energy level over time can be reported, such as over a rolling window of time. RMS, peak, max/min, or other levels can be indicated, as well as real-time vibration levels. Acoustic energy can be indicated in sound pressure levels, such as decibels (dB), Joules, or other units.

Fan assemblies 340-342 include moving elements, such as motor elements 343-345 and fan blades 346-348, to force air to flow within enclosure 301. However, movement of elements of the fan assemblies can introduce acoustic disturbances into enclosure 301, such as vibration, acoustic noise, beat frequency noise, among other disturbances. For example, phase differences and speed differences between each of fan blades 346-348 can lead to varied acoustic noise within enclosure 301 along with any associated vibrations. These vibrations can be induced into the chassis, structure, or casing of data storage system 300 and be transferred into any of the HDDs. In FIG. 3, arrows 371-376 indicate possible vectors of acoustic noise within enclosure 301, which can include reflections, interference, or other propagation characteristics. Once this acoustic noise is introduced into any of the HDDs, associated vibrations can lead to degraded performance due to interaction with electromechanical elements of the HDDs, such as read/write heads, armatures, servos, voicecoil actuators, or other elements.

To monitor acoustic disturbances within enclosure 301, controller 310 can interface with sensors 311 which are distributed within enclosure 301. These sensors, which can include accelerometers, microphones, or other sensors, can provide an indication of vibration levels or acoustic sound pressure levels for various predetermined locations within enclosure 301. In conjunction with, or alternatively, each HDD can also monitor vibration levels and report these levels to controller 310. For example, each HDD can include a vibration sensor 357 which monitors vibration levels for each HDD which are reported to controller 310.

In other examples, read/write head positional information is monitored by each HDD and delivered to controller 310. This read/write head positional information comprises deviations between target read/write head positions and actual read/write head positions. The deviations can be related to acoustic disturbances produced by fan assemblies 340-342. Write quality can be measured by HDDs each detecting squeezed sectors during write processes based on at least position error signal (PES) metrics monitored during the write processes. The PES metrics can indicate how accurately a target position is met by an actual position of a read/write head over the media during a write process. Track-to-track differences, or delta PES metrics, can also be monitored to identify variability in the spacing between adjacent tracks. These PES metrics or delta PES metrics can be employed as a measure of acoustic disturbance or vibration for the HDDs. PES metrics or delta PES metrics for each HDD can be provided to controller 310 for use in monitoring acoustic disturbance or vibration levels within enclosure 310. In further examples, read/write head positioning measurements can indicate indirect measurements of acoustic disturbance levels that can be measured and reported to controller 310. These measurements include track misregistration (TMR), write-to-write track misregistration (WW-TMR), media bit error rates, quantities of bits needing error correction during reads from the media, or other indirect measures of vibration.

In addition to acoustic disturbances or vibrational information, controller 310 also monitors rotational properties of fan assemblies 340-342. In FIG. 3, each of fan assemblies 340-342 includes fan motor elements 343-345 and fan blades 346-348 and can rotate at an associated rotational speed, which can be indicated in revolutions per minute (RPMs), or any angular speed measurement. These associated speeds can be monitored by controller 310. For example motor driver 334-336 can monitor and report speed information and phase information over links 322, 324, and 326 to controller 310. In some examples, controller 310 commands fan assemblies 340-342 to rotate at a selected rotation rates and phases, and fan assemblies 340-342 can report feedback regarding measured or actual rotation rates and phases to controller 310.

The speed or rotation rate of a fan can be referred to as a frequency of operation, which reflects the speed of a particular fan to complete one revolution. Phase information for fan blades 346-348 can also be monitored For example, each fan can have a rotational phase relationship to each other fan based on a present angle of rotation. A reference angle can also be employed which baselines rotational angles and from which phase differences can also be determined. The phase can be indicated for a particular fan, such as a current rotation angle from a designated origin angle for that fan. Phase information can also include phase differences or phase relationships among more than one fan, such as a current rotation angle difference between two fan assemblies.

During operation of data storage system 300, as detailed in FIG. 4, controller 310 can make various adjustments to the speeds and phases of fan assemblies 340-342 to enhance the operation of the HDDs in data storage system 300. This enhanced operation can provide for more reliable write and read operations by reducing acoustic disturbances for particular HDDs or on the average within enclosure 301.

One or more acoustic resonant frequencies associated with the HDDs can be identified for data storage system 300. These resonant frequencies can be based on the geometry of enclosure 301, or on various mechanical resonances for electromechanical elements of the HDDs, such as read/write head assemblies. These resonances can be modeled or simulated prior to operation of data storage system 300, or can instead be measured in situ by sensors 311 and sensor elements of the HDDs. For example, measuring in situ can include measuring acoustic disturbances within enclosure 301, receiving error rates and read/write head positional deviations of the HDDs, or receiving positional error information associated with read/write heads as measured by the HDDs, among other operational properties. These properties can be correlated to various frequencies and phase relationship of fan assemblies 340-342 to establish a table or other data structure relating rotational properties to their effect on elements of data storage system 300.

During normal operation, rotational properties for fan assemblies 340-342 can be established based at least on the one or more acoustic resonant frequencies identified for enclosure 301 and the HDDs, among other considerations. For example, areas or zones of constructive or destructive interference can be identified for enclosure 301 and the rotational properties for fan assemblies 340-342 can be modified to reduce constructive interference or increase destructive interference near vulnerable HDDs. These vulnerable HDDs can include ones performing quantities of read or write operations above a threshold quantity, as opposed to idle HDDs or HDDs with traffic below a predetermined threshold.

The various acoustic resonant frequencies and zones of constructive or destructive interference can be mapped over the geometry of data storage system 300 and stored by controller 310 for reference during control of the rotational properties of fan assemblies 340-342. Each HDD can have a particular zone assigned thereto which can be referenced by controller 310 when adjustments are being determined.

As a simplified zone assignment, FIG. 3 shows HDDs 351A/D in a first zone nearest to fan assemblies 340-342 as having a first acoustic disturbance level, HDDs 351B/C in a second zone nearest to fan assemblies 340-342 as having a second acoustic disturbance level, HDDs 352B-C and 353B-C in a third zone having a third acoustic disturbance level, and HDDs 352A/D and 353A/D in a fourth zone having a fourth acoustic disturbance level. Disturbance caused by fan noise typically drops rapidly with distance from the assocaited fan elements. By adjusting the fan phase values, as discussed herein, controller 310 can reduce acoustic disturbances in the middle of the HDD array, namely the second zone or third zone, at the expense of increased acoustic disturbances on the outer edge of the HDD array, namely the first zone or fourth zone. Alternatively, the first zone or fourth can be controlled to have decreased acoustic disturbance at the expense of the second zone or third zone. Other zones and acoustic arrangements will vary based on the installation-specific configuration of HDDs and enclosure geometries. Other acoustic propagation properties can exist, such as shown by direct and reflected acoustic vectors 371-376 in FIG. 3.

In operation 403 of FIG. 4, when fan assemblies 340-342 are operating in a steady state operation, data storage system 300 can operate (406) fan assemblies 340-342 at matched frequency and phase, and within a frequency band attenuated by silencer 360. Silencer 360 can reduce acoustic disturbances for a particular range of acoustic frequencies, such as an acoustic attenuator for specific frequencies or bands of frequencies. Controller 310 can select frequencies for fan assemblies 340-342 which lie within the attenuation range of silencer 360. In addition, controller 310 can avoid operating fan assemblies 340-342 within the resonant frequencies discussed above for enclosure 301 and the HDDs. Thus, controller 310 can establish a steady state rotational speed for fan assemblies 340-342 as within the acoustic attenuation range of silencer 360 and avoid other sensitive frequency bands.

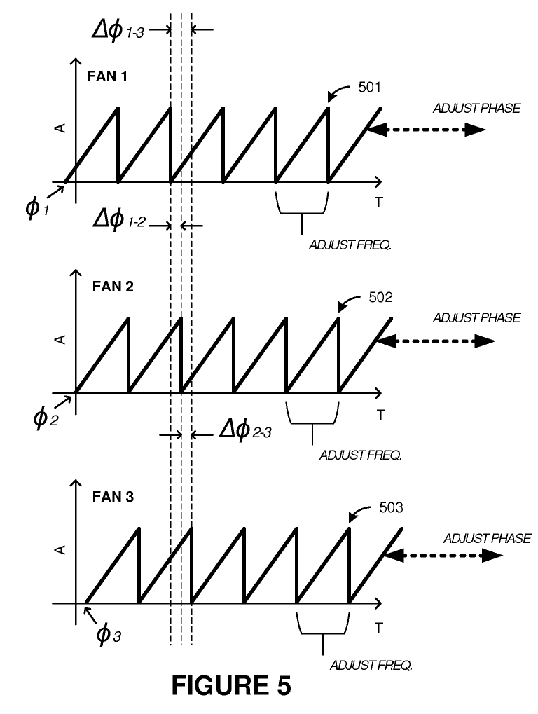

However, rotational speed or frequency of each of fan assemblies 340-342 might only be part of the influence on acoustic disturbances caused by fan assemblies 340-342. Frequency relationships between fan assemblies 340-342 can also affect acoustic disturbances, such as when beat frequencies occur among fan assemblies 340-342. Beat frequencies within enclosure 301 can be caused by selected rotational properties. Beat frequencies can occur when one or more of fan assemblies 340-342 rotate at the same or similar rotational speed. Differences in frequencies of fan assemblies 340-342 can lead to “beating” between fan assemblies 340-342 at frequencies correlated to the frequency differences, and thus acoustic disturbances occur at the beat frequencies. For two fan assemblies operating at the same frequency, phase differences between the rotating elements, such as fan blades, defines interference patterns formed within enclosure 301. However, if the frequencies of the rotating elements of fan assemblies are different, the relative phase is continuously and periodically changing and results in a beating sound. Selected beat frequencies can be desirable or undesirable, and controller 310 can selectively operate fan assemblies 340-342 to introduce or avoid such beat frequencies. A further discussion of frequency and phase selection regarding beat frequencies is shown in FIG. 5 below.

In operation 404 of FIG. 4, when fan assemblies 340-342 are in the process of changing speed, such as due to increased temperatures within enclosure 301 or increased workload of the HDDs, then data storage system 300 can transition (407) fan speeds to avoid lingering in resonant frequency bands for the HDDs. Furthermore, data storage system 300 can transition fan speeds slower through frequency bands attenuated by silencer 360. During changes in temperature within enclosure 301, it can be desirable to change speeds or frequencies of fan assemblies 340-342 to alter airflow speeds or airflow properties within enclosure 301 and thus alter temperature within enclosure 301. For example, during heavy workloads, temperature within enclosure 301 can increase, and fan assemblies 340-342 can be increased in speed to compensate with higher airflow volume. Likewise, when heavy workloads subside, speeds of fan assemblies 340-342 can be decreased accordingly.

During changes in speed of fan assemblies 340-342, controller 310 can accelerate or decelerate rotation of fan assemblies 340-342 more quickly through sensitive frequencies than through other frequencies. Moreover, controller 310 can be configured to ramp a rotational speed of fan assemblies 340-342 more rapidly through rotational speeds associated with frequencies not within the acoustic attenuation range of silencer 360 than through rotational speeds associated with frequencies within the acoustic attenuation range.

In operation 405 of FIG. 4, when sequential writes are occurring in ones of the HDDs (405), then data storage system 300 can operate (408) fan assemblies at frequencies and phases selected to minimize disturbances to the HDDs performing sequential write operations. The disturbances can be characterized using position error signal (PES) measurements performed by the HDDs during write operations. Likewise, even when ones of the HDDs are not performing sequential write operations, those particular HDDs might be more sensitive to disturbances from fan assemblies 340-342, as indicated by PES metrics for those HDDs. The increased sensitivity to disturbances might occur from electromechanical elements of the HDDs being sensitive to particular frequencies of fan assemblies 340-342, or might occur from positioning within enclosure 301 which experience constructive interference from noise of fan assemblies 340-342.

HDDs performing sequential write operations can be more sensitive to acoustic disturbances than those sitting idle, performing read operations, or non-sequential write operations. In many examples, HDDs can employ SMR techniques for writing data which rely upon precise positioning of read/write heads to slightly overlap adjacent tracks on the storage media without overwriting already-written data on those adjacent tracks. Vibration due to acoustic disturbances can cause inaccuracies in the positioning of the read/write heads, and lead to data corruption or data loss. Also, these acoustic disturbances can lead to reduced storage device performance. For example, in a noisy environment, a HDD may fail a storage operation and retry the storage operation multiple times before succeeding. This results in delays and reduced throughput. These HDDs can indicate an associated status to controller 310 or controller 310 can monitor write operations received by data storage system 300 to identify when particular HDDs are engaging in sequential write operations. The HDDs can measure PES information, and controller 310 can identify when deviations of the PES information are greater than a PES threshold for each HDD.

Rotational properties of fan assemblies 340-342, such as speed or phase, can be altered when PES information for one or more HDD exceeds a threshold level. For example, a particular HDD can be singled out by controller 310 for attenuation of acoustic disturbance during a sequential write operation of that HDD. This attenuation can include changing a speed of fan assemblies 340-342 to create acoustic disturbances within a frequency band of silencer 360. This attenuation can include changing a speed of fan assemblies 340-342 to alter constructive interference patterns within enclosure 301 to reduce acoustic disturbances for that HDD. When the sequential write operation is complete, then the rotational properties of fan assemblies 340-342 can be returned to a previous level, or can be further altered to accommodate sequential writes for a different HDD. Typically, fan noise increases with fan speed. In some examples, controller 310 can reduce fan speed or halt rotation temporarily to reduce fan-originated disturbances to selected HDDs while those HDDs are performing sensitive storage operations, such as writes. Fan assemblies proximate to selected ones of HDDs that are performing vibration-sensitive operations can be reduced in speed or halted entirely. Fan speed can eventually be returned to the previous speed to prevent overheating within enclosure 301, but the temporary speed change can provide for a temporary reduction in acoustic disturbance to individual HDDs. In this manner, controller 310 can selectively reduce acoustic disturbances experienced by selected HDDs within enclosure 301 to advantageously enhance the reliability and success of the storage operations, such as sequential write operations, thereby reducing error rates for the HDDs.

As discussed above, relative frequency information of fan assemblies 340-342 can also be considered when altering the properties of fan assemblies 340-342 to accommodate various HDDs during sequential write operation. For example, frequency relationships between ones of fan assemblies 340-342 can be established to minimize beat frequencies which affect read/write head components of the HDDs during sequential write operations. Also, phase relationships can be controlled to alter interference patterns within enclosure 301 to a more desirable pattern, such as to have destructive interference positioned by an individual HDD at the expense of contstructive interference at another location within enclosure 301. Phase relationships can also be adjusted to alter interference patterns to reduce a mean or average noise level in enclosure 301.

As a further example of altering frequency and phase information for fan assemblies 340-342, FIG. 5 is presented. FIG. 5 shows three graphs 501-503 which indicate drive signals for each of fan assemblies 340-342. These drive signals can be used to drive motor drivers 334-336, such as over links 321, 323, and 325, although these drive signals can also be merely representative of frequency and phase information for fan assemblies 340-342.

In FIG. 5, fan 1 is operated with a first phase and frequency, shown in graph 501. Fan 2 is operated with a second phase and frequency, shown in graph 502. Fan 3 is operated with a third phase and frequency, shown in graph 503. Phase adjustments correspond to changes of the associated waveform with respect to an origin or reference point in time, while frequency adjustments correspond to changes in a frequency of each waveform.

Each waveform has an associated absolute phase, as referenced to the origin of each graph. Specifically, fan 1 has phase φ₁, fan 2 has phase φ₂, and fan 3 has a phase φ₃, each of which can be altered independently by controller 310. Differences in phase among each fan can lead to phase differences, as indicated by Δφ₁₋₃, Δφ₁₋₂, and Δφ₂₋₃. These phase differences can be associated with beat frequencies as discussed above.

FIG. 6 is a block diagram illustrating control system 610. Control system 610 handles control and storage operations for a storage assembly. Control system 610 can be an example of control system 111 of FIG. 1, controller 310 of FIG. 3, or included in elements of a host system, although variations are possible. When control system 610 is included in a data storage assembly, control system 610 receives storage operations from host systems over storage link 660 by host interface 611. Write data can be received in one or more write operations, and read data can be provided to hosts responsive to one or more read operations.

Control system 610 includes host interface (I/F) 611, processing circuitry 612, drive controller 613, storage system 614, and fan controller 616. Furthermore, control system 610 includes firmware 615 which includes acoustic disturbance monitoring module 620 and fan adjustment module 621 which, when executed by at least processing circuitry 612, operates as described below.

Host interface 611 includes one or more storage interfaces for communicating with host systems, networks, and the like over at least link 660. Host interface 611 can comprise transceivers, interface circuitry, connectors, buffers, microcontrollers, and other interface equipment. Host interface 611 can also include one or more I/O queues which receive storage operations over link 660 and buffers these storage operations for handling by processing circuitry 612. Link 660 can include one or more Ethernet interfaces, SATA interfaces, SAS interfaces, FibreChannel interfaces, USB interfaces, SCSI interfaces, InfiniBand interfaces, NVMe interfaces, or IP interfaces, which allows for the host system to access the storage capacity of HDD assembly.

Processing circuitry 612 can comprise one or more microprocessors and other circuitry that retrieves and executes firmware 615 from storage system 614. Processing circuitry 612 can be implemented within a single processing device but can also be distributed across multiple processing devices or sub-systems that cooperate in executing program instructions. Examples of processing circuitry 612 include general purpose central processing units, application specific processors, and logic devices, as well as any other type of processing device, combinations, or variations thereof. In some examples, processing circuitry 612 includes a system-on-a-chip device or microprocessor device, such as an Intel Atom processor, MIPS microprocessor, and the like.

Drive controller 613 can include one or more drive control circuits and processors which can control various data redundancy handling among the various data storage devices of a storage assembly. Drive controller 613 also includes storage interfaces 661, such as SAS interfaces to couple to the various data storage devices in a storage assembly. In some examples, drive controller 613 and processing circuitry 612 communicate over a peripheral component interconnect express (PCIe) interface or other communication interfaces. In some examples, drive controller 613 comprises a RAID controller, RAID processor, or other RAID circuitry. In other examples, drive controller 613 handles management of a particular recording technology, such as SMR or HAMR techniques. As mentioned herein, elements and functions of drive controller 613 can be integrated with processing circuity 313.

Fan controller 616 comprises circuitry configured to control rotational properties of one or more fan assemblies over fan control links 662. In some examples, fan controller 616 identifies frequency and phase characteristics for one or more fans and determines one or more drive signals to operate the fans accordingly. These drive signals can include digital or analog signals indicated over links 662. These drive signal can drive fan assemblies directly or can be directed to further control circuitry, such as shown in FIG. 3.

Storage system 614 can comprise any non-transitory computer readable storage media readable by processing circuitry 612 or drive controller 613 and capable of storing firmware 615. Storage system 614 can include volatile and nonvolatile, removable and non-removable media implemented in any method or technology for storage of information, such as computer readable instructions, data structures, program modules, or other data. In addition to storage media, in some implementations storage system 614 can also include communication media over which firmware 615 can be communicated. Storage system 614 can be implemented as a single storage device but can also be implemented across multiple storage devices or sub-systems co-located or distributed relative to each other. Storage system 614 can comprise additional elements, such as a controller, capable of communicating with processing circuitry 612. Examples of storage media of storage system 614 include random access memory, read only memory, magnetic disks, optical disks, flash memory, SSDs, phase change memory, magnetic cassettes, magnetic tape, magnetic disk storage or other magnetic storage devices, or any other medium which can be used to store the desired information and that can be accessed by an instruction execution system, as well as any combination or variation thereof, or any other type of storage media.

Firmware 615 can be implemented in program instructions and among other functions can, when executed by control system 610 in general or processing circuitry 612 in particular, direct control system 610 or processing circuitry 612 to operate data storage systems as described herein. Firmware 615 can include additional processes, programs, or components, such as operating system software, database software, or application software. Firmware 615 can also comprise software or some other form of machine-readable processing instructions executable by processing circuitry 612.

In at least one implementation, the program instructions can include first program instructions that direct control system 610 to handle read and write operations among the data storage devices, monitor acoustic disturbance information or vibration characteristics for data storage devices or other components such as fans, power supplies, or other components (acoustic disturbance monitoring module 620), take action to alter fan speeds (e.g. frequencies) or phases responsive to acoustic disturbance characteristics (fan adjustment module 621), among other operations.

In general, firmware 615 can, when loaded into processing circuitry 612 and executed, transform processing circuitry 612 overall from a general-purpose computing system into a special-purpose computing system customized to operate as described herein. Encoding firmware 615 on storage system 614 can transform the physical structure of storage system 614. The specific transformation of the physical structure can depend on various factors in different implementations of this description. Examples of such factors can include, but are not limited to the technology used to implement the storage media of storage system 614 and whether the computer-storage media are characterized as primary or secondary storage. For example, if the computer-storage media are implemented as semiconductor-based memory, firmware 615 can transform the physical state of the semiconductor memory when the program is encoded therein. For example, firmware 615 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A data storage system, comprising:
a plurality of data storage devices configured for storage and retrieval of data;
an enclosure configured to encase and physically support the plurality of data storage devices;
one or more fan assemblies configured to provide airflow within the enclosure;
a control processor configured to monitor rotational properties of the one or more fan assemblies and make adjustments to the rotational properties to reduce acoustic disturbances experienced by selected ones of the plurality of data storage devices within the enclosure.

2. The data storage system of claim 1, comprising:
the control processor configured to receive positional error information associated with read/write heads of the plurality of data storage devices and make the adjustments to the rotational properties based at least on the positional error information.

3. The data storage system of claim 1, comprising:
the control processor configured to monitor the rotational properties of the one or more fan assemblies to determine one or more beat frequencies within the enclosure caused by the rotational properties and responsively make the adjustments to the rotational properties based at least on the one or more beat frequencies.

4. The data storage system of claim 1, comprising:
the control processor configured to make the adjustments to the rotational properties to reduce the acoustic disturbances experienced by selected ones of the plurality of data storage devices that are performing vibration-sensitive operations.

5. The data storage system of claim 1, comprising:
the control processor configured to identify one or more acoustic resonant frequencies associated with read/write heads of selected ones of the plurality of data storage devices and establish the rotational properties based at least on the one or more acoustic resonant frequencies.

6. The data storage system of claim 1, comprising:
the control processor configured to make the adjustments to the rotational properties to reduce an average level of the acoustic disturbances experienced by the plurality of data storage devices within the enclosure.

7. The data storage system of claim 1, comprising:
the control processor configured to alter at least phase relationships among the one or more fan assemblies to alter interference patterns associated with the acoustic disturbances experienced by the selected ones of the plurality of data storage devices within the enclosure.

8. The data storage system of claim 1, further comprising:
an acoustic attenuator coupled to the one or more fan assemblies and having an acoustic attenuation range; and
the control processor configured to ramp a rotational speed of the one or more fan assemblies more rapidly through rotational speeds associated with frequencies not within the acoustic attenuation range than through rotational speeds associated with frequencies within the acoustic attenuation range; and
the control processor configured to establish a steady state rotational speed of the one or more fan assemblies as within the acoustic attenuation range.

9. The data storage system of claim 1, comprising:
the control processor configured to reduce a rotational speed of at least one of the fan assemblies proximate to selected ones of the plurality of data storage devices that are performing vibration-sensitive operations to reduce the acoustic disturbances experienced by the selected ones of the plurality of data storage devices.

10. A method of operating a data storage system comprising one or more fan assemblies that provide airflow within an enclosure housing a plurality of data storage devices, the method comprising:
in a control processor, monitoring rotational properties of the one or more fan assemblies;
in the control processor, making adjustments to the rotational properties to reduce acoustic disturbances experienced by selected ones of the plurality of data storage devices within the enclosure.

11. The method of claim 10, further comprising:
in the control processor, receiving positional error information associated with read/write heads of the plurality of data storage devices and making the adjustments to the rotational properties based at least on the positional error information.

12. The method of claim 10, further comprising:
in the control processor, monitoring the rotational properties of the one or more fan assemblies to determine one or more beat frequencies within the enclosure caused by the rotational properties and responsively making the adjustments to the rotational properties based at least on the one or more beat frequencies.

13. The method of claim 10, further comprising:
in the control processor, making the adjustments to the rotational properties to reduce the acoustic disturbances experienced by selected ones of the plurality of data storage devices that are performing vibration-sensitive operations.

14. The method of claim 10, further comprising:
in the control processor, identifying one or more acoustic resonant frequencies associated with read/write heads of selected ones of the plurality of data storage devices and establishing the rotational properties based at least on the one or more acoustic resonant frequencies.

15. The method of claim 10, further comprising:
in the control processor, making the adjustments to the rotational properties to reduce an average level of the acoustic disturbances experienced by the plurality of data storage devices within the enclosure.

16. The method of claim 10, further comprising:
in the control processor altering at least phase relationships among the one or more fan assemblies to alter interference patterns associated with the acoustic disturbances experienced by the selected ones of the plurality of data storage devices within the enclosure.

17. The method of claim 10, wherein the enclosure comprises an acoustic attenuator coupled to the one or more fan assemblies and having an acoustic attenuation range; and further comprising:
in the control processor, ramping a rotational speed of the one or more fan assemblies more rapidly through rotational speeds associated with frequencies not within the acoustic attenuation range than through rotational speeds associated with frequencies within the acoustic attenuation range; and
in the control processor, establishing a steady state rotational speed of the one or more fan assemblies as within the acoustic attenuation range.

18. The method of claim 10, further comprising:
in the control processor, reducing a rotational speed of at least one of the fan assemblies proximate to selected ones of the plurality of data storage devices that are performing vibration-sensitive operations to reduce the acoustic disturbances experienced by the selected ones of the plurality of data storage devices.

19. A control system for a data storage system that comprises one or more fan assemblies to provide airflow within an enclosure that houses one or more data storage devices, the control system comprising:
a communication interface configured to receive data related to rotational properties of the one or more fan assemblies;
control circuitry configured to monitor acoustic disturbances within the enclosure;
the control circuitry configured to determine altered rotational properties for the one or more fan assemblies to reduce acoustic disturbances experienced by the one or more data storage devices within the enclosure; and
the communication interface configured to transfer control instructions indicating the altered rotational properties for receipt by the one or more fan assemblies.

20. The control system of claim 19, comprising:
the control circuitry configured to receive positional error information associated with read/write heads of the one or more of data storage devices and determine the altered rotational properties based at least on the positional error information.
